(19) United States
(12) Patent Application Publication
(10) Pub. No.: US 2015/0161244 A1
(43) Pub. Date: Jun. 11, 2015

(54) Systems and Methods for Confirmation Processing

(71) Applicant: Tencent Technology (Shenzhen) Company Limited, Shenzhen (CN)

(72) Inventor: Yabei Guan, Shenzhen (CN)

(21) Appl. No.: 14/624,803

(22) Filed: Feb. 18, 2015

Related U.S. Application Data
(63) Continuation of application No. PCT/CN2014/081533, filed on Jul. 3, 2014.

(30) Foreign Application Priority Data
Nov. 19, 2013 (CN) 201310585658.9

(51) Int. Cl. G06F 17/30

(52) U.S. Cl. CPC G06F 17/30675; G06F 17/30386

(57) ABSTRACT

Systems and methods are provided for confirmation processing. For example, a server generates a verification graph upon detecting an event to be confirmed that is sent according to an operation of a target account; the server sends a confirmation request message that contains the verification graph to a client corresponding to the target account; a client calls and displays a graphic input interface upon receiving the confirmation request message; the client displays the verification graph contained in the confirmation request message; the client obtains a first graph input on the graphic input interface; in response to the first graph matching with the verification graph, the client returns a confirmation response message to the server; the server confirms the event upon receiving the confirmation response message; and the server responds to one or more operations of the target account.

### CROSS-REFERENCES TO RELATED APPLICATIONS

The application claims priority to Chinese Patent Application No. 201310585658.9, filed. Nov. 19, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to confirmation processing. But it would be recognized that the invention has a much broader range of applicability.

User confirmations are frequently requested in many scenarios of Internet activities. For example, after a user clicks a button for buying a commodity, the user is often requested to confirm the purchase before a payment procedure is initiated. When a payment needs to be made in an Internet transaction, a payment server usually needs to request a payer to confirm whether to perform an account transfer for the payment. Before a downloading process for certain data starts, a user who initiates the downloading process is often requested to confirm whether to start downloading. In certain mobile communications systems, users may also be requested to confirm whether they want to be connected to a network with a particular protocol.

Currently, a user confirmation is usually requested as follows: a server is configured to send a confirmation request message to a user terminal. When the user terminal receives the confirmation request message, a dialog window or a confirmation page including a “Confirm” button and a “Cancel” button is displayed on the terminal's screen. If a user presses the “Confirm” button, the user terminal returns a confirmation response message and the server immediately executes related operations, such as payments and downloading. If the user presses the “Cancel” button, the user terminal returns a cancellation response message and the server accordingly cancels related operations, such as payments and downloading.

The above-noted conventional technology has some disadvantages. For example, in a dialog window or on a confirmation page providing a “Confirm” button and a “Cancel” button, a user can complete confirmation simply by pressing a button. Thus, a user may press a wrong button inadvertently or due to other touching events, which may cause inconvenience and user loss.

Hence it is highly desirable to improve the techniques for confirmation processing.

### BRIEF SUMMARY OF THE INVENTION

According to one embodiment, a method is provided for confirmation processing. For example, a server generates a verification graph upon detecting an event to be confirmed that is sent according to an operation of a target account; the server sends a confirmation request message that contains the verification graph to a client corresponding to the target account; a client calls and displays a graphic input interface upon receiving the confirmation request message; the client displays the verification graph contained in the confirmation request message; the client obtains a first graph input on the graphic input interface; in response to the first graph matching with the verification graph, the client returns a confirmation response message to the server; the server confirms the event upon receiving the confirmation response message; and the server responds to one or more operations of the target account.

According to another embodiment, a method is provided for confirmation processing. For example, a server sends a confirmation request message to a client corresponding to a target account upon detecting an event to be confirmed that is sent according to an operation of the target account; the client calls a graphic input interface upon receiving the confirmation request message; the client displays the graphic input interface; the client generates and displays a verification graph; the client obtains a first graph input on the graphic input interface; in response to the first graph matching with the verification graph, the client returns a confirmation response message to the server; the server confirms the event upon receiving the confirmation response message; and the server responds to one or more operations of the target account.

According to yet another embodiment, a method is provided for confirmation processing. For example, a server generates a verification graph upon detecting an event to be confirmed that is sent according to an operation of a target account; the server sends a confirmation request message that contains the verification graph to a client corresponding to the target account; a client calls and displays a graphic input interface upon receiving the confirmation request message; the client displays the verification graph contained in the confirmation request message; the client obtains a first graph input on the graphic input interface; the client returns a confirmation response message containing the first graph to the server; in response to the first graph matching with the verification graph, the server confirms the event responds to one or more operations of the target account.

In one embodiment, a method is provided for confirmation processing. For example, a graphic input interface is called and displayed upon receiving a confirmation request message that contains a verification graph from a server; the verification graph contained in the confirmation request message is displayed; a first graph input on the graphic input interface is obtained; and in response to the first graph matching with the verification graph, a confirmation response message is returned to the server so that the server confirms a corresponding event according to the confirmation response message.

In another embodiment, a method is provided for confirmation processing. For example, a verification graph is generated upon detecting an event to be confirmed that is sent according to an operation of a target account; a confirmation request message that contains the verification graph is sent to a client corresponding to the target account; the event is confirmed upon receiving a confirmation response message returned by a client according to the verification graph; and one or more operations of the target account are responded to.

In yet another embodiment, a method is provided for confirmation processing. For example, a graphic input interface is called and displayed upon receiving a confirmation request message from a server; a verification graph is generated and displayed; a first graph input on the graphic input interface is obtained; and in response to the first graph matching with the verification graph, a confirmation response message is returned to the server so that the server confirms a corresponding event according to the confirmation response message.

According to one embodiment, a method is provided for confirmation processing. For example, a verification graph is generated upon detecting an event to be confirmed that is sent according to an operation of a target account; a confirmation request message that contains the verification graph is sent to a client corresponding to the target account; a confirmation response message containing a first graph is received from the client, the first graph being related to the verification graph; in response to the first graph matching with the verification graph, the event is confirmed and one or more operations of the target account are responded to.

According to another embodiment, a confirmation-processing device includes: a calling module configured to call and display a graphic input interface upon receipt of a confirmation request message containing a verification graph from a server; a display module configured to display the verification graph contained in the confirmation request message; and a response module configured to obtain a first graph input on the graphic input interface, and in response to the first graph matching with the verification graph, return a confirmation response message to the server so that the server confirms a corresponding event according to the confirmation response message.

According to yet another embodiment, a confirmation-processing device includes: a request module configured to generate a verification graph upon detecting an event to be confirmed that is sent according to an operation of a target account and send a confirmation request message that contains the verification graph to a client corresponding to the target account; and a confirmation module configured to confirm the event upon receiving a confirmation response message returned by a client according to the verification graph and respond to one or more operations of the target account.

In one embodiment, a confirmation-processing device includes: a calling module configured to call and display a graphic input interface upon receiving a confirmation request message from a server; a generation module configured to generate and display a verification graph; and a response module configured to obtain a first graph input on the graphic input interface, and in response to the first graph matching with the verification graph, return a confirmation response message to the server so that the server confirms a corresponding event according to the confirmation response message.

In another embodiment, a confirmation-processing device includes: a request module configured to generate a verification graph upon detecting an event to be confirmed that is sent according to an operation of a target account and send a confirmation request message that contains the verification graph to a client corresponding to the target account; a receiving module configured to receive a confirmation response message containing a first graph from the client, the first graph being related to the verification graph; and a confirmation module configured to, in response to the first graph matching with the verification graph, confirm the event and respond to one or more operations of the target account.

In yet another embodiment, a non-transitory computer readable storage medium includes programming instructions for confirmation processing. The programming instructions are configured to cause one or more data processors to execute certain operations. For example, a graphic input interface is called and displayed upon receiving a confirmation request message that contains a verification graph from a server; the verification graph contained in the confirmation request message is displayed; a first graph input on the graphic input interface is obtained; and in response to the first graph matching with the verification graph, a confirmation response message is returned to the server so that the server confirms a corresponding event according to the confirmation response message.

According to one embodiment, a non-transitory computer readable storage medium includes programming instructions for confirmation processing. The programming instructions are configured to cause one or more data processors to execute certain operations. For example, a verification graph is generated upon detecting an event to be confirmed that is sent according to an operation of a target account; a confirmation request message that contains the verification graph is sent to a client corresponding to the target account; the event is confirmed upon receiving a confirmation response message returned by a client according to the verification graph; and one or more operations of the target account are responded to.

According to another embodiment, a non-transitory computer readable storage medium includes programming instructions for confirmation processing. The programming instructions are configured to cause one or more data processors to execute certain operations. For example, a graphic input interface is called and displayed upon receiving a confirmation request message from a server; a verification graph is generated and displayed; a first graph input on the graphic input interface is obtained; and in response to the first graph matching with the verification graph, a confirmation response message is returned to the server so that the server confirms a corresponding event according to the confirmation response message.

According to yet another embodiment, a non-transitory computer readable storage medium includes programming instructions for confirmation processing. The programming instructions are configured to cause one or more data processors to execute certain operations. For example, a verification graph is generated upon detecting an event to be confirmed that is sent according to an operation of a target account; a confirmation request message that contains the verification graph is sent to a client corresponding to the target account; a confirmation response message containing a first graph is received from the client, the first graph being related to the verification graph, in response to the first graph matching with the verification graph, the event is confirmed and one or more operations of the target account are responded to.

In one embodiment, a confirmation-processing system includes: a client; and a server. The server is configured to generate a verification graph upon detecting an event to be confirmed that is sent according to an operation of a target account and send a confirmation request message that contains the verification graph to a client corresponding to the target account. The client is configured to call and display a graphic input interface upon receiving the confirmation request message and display the verification graph contained in the confirmation request message. The client is further configured to obtain a first graph input on the graphic input interface, and in response to the first graph matching with the verification graph, return a confirmation response message to the server. The server is further configured to confirm the event and respond to one or more operations of the target account.

In another embodiment, a confirmation-processing system includes: a client; and a server. The server is configured to send a confirmation request message to a client corresponding to a target account upon detecting an event to be confirmed that is sent according to an operation of the target account. The client is configured to call and display a graphic input interface upon receiving the confirmation request message, and generate and display a verification graph. The client is further configured to obtain a first graph input on the graphic input interface, and in response to the first graph matching with the verification graph, return a confirmation response message to the server. The server is further configured to confirm the event upon receiving the confirmation response message and respond to one or more operations of the target account.

For example, the systems, devices and methods disclosed herein are configured to implement confirmation processing based on graphic verification to obtain user intention of confirmation and to prevent user loss due to improper operations or improper button-pressing.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for confirmation processing according to one embodiment of the present invention.

FIG. 2 is a simplified diagram showing a graphic input interface for displaying a verification graph according to one embodiment of the present invention.

FIG. 3 is a simplified diagram showing a method for confirmation processing according to another embodiment of the present invention.

FIG. 4 is a simplified diagram showing a method for confirmation processing according to yet another embodiment of the present invention.

FIG. 5 is a simplified diagram showing a method for confirmation processing according to yet another embodiment of the present invention.

FIG. 6 is a simplified diagram showing a method for confirmation processing according to yet another embodiment of the present invention.

FIG. 7 is a simplified diagram showing a method for confirmation processing according to yet another embodiment of the present invention.

FIG. 8 is a simplified diagram showing a method for confirmation processing according to yet another embodiment of the present invention.

FIG. 9 is a simplified diagram showing a method for confirmation processing according to yet another embodiment of the present invention.

FIG. 10 is a simplified diagram showing a device for confirmation processing according to one embodiment of the present invention.

FIG. 11 is a simplified diagram showing a user terminal for confirmation processing according to one embodiment of the present invention.

FIG. 12 is a simplified diagram showing a device for confirmation processing according to another embodiment of the present invention.

FIG. 13 is a simplified diagram showing a server for confirmation processing according to one embodiment of the present invention.

FIG. 14 is a simplified diagram showing a device for confirmation processing according to yet another embodiment of the present invention.

FIG. 15 is a simplified diagram showing a user terminal for confirmation processing according to another embodiment of the present invention.

FIG. 16 is a simplified diagram showing a device for confirmation processing according to yet another embodiment of the present invention.

FIG. 17 is a simplified diagram showing a server for confirmation processing according to another embodiment of the present invention.

FIG. 18 is a simplified diagram showing a confirmation-processing system according to one embodiment of the present invention.

FIG. 19 is a simplified diagram showing a confirmation-processing system according to another embodiment of the present invention.

### DETAILED DESCRIPTION OF THE INVENTION

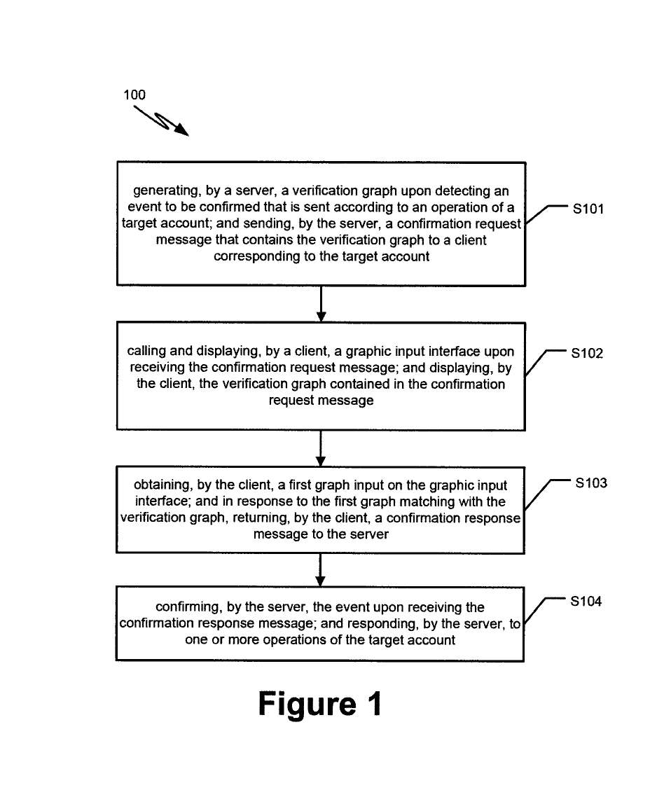

FIG. 1 is a simplified diagram showing a method for confirmation processing according to one embodiment of the present invention. The diagram is merely an example, which should not unduly limit the scope of the claims. One of ordinary skill in the art would recognize many variations, alternatives, and modifications. The method 100 includes at least processes S101-S104.

According to some embodiments, the method 100 is used between a client and a server for certain scenarios in which operations such as payments, purchases, and downloads can be performed upon user confirmation. For example, on the client, one or more confirmation applications can be configured to implement the corresponding functions. As an example, the server generates a verification graph, and the client calculates and confirms graph similarity matching.

According to one embodiment, during the process S101, the server, upon detecting an event to be confirmed that is sent according to an operation of the target account, generates a verification graph and sends a confirmation request message that contains the verification graph to the client corresponding to the target account. For example, the server detects the event to be confirmed if the server detects that the operation of the target account needs to be confirmed by a terminal user. As an example, when a user needs to be asked to confirm an account transfer operation after initiating a series of payment operations by using the user's payment account, an event to be confirmed by the user has occurred. In another example, upon detecting the event to be confirmed, the server randomly generates a simple geometric graph, a numerical graph, and/or a character graph as the verification graph. Then, the server encodes the verification graph and sends a confirmation request message carrying the graph to the client corresponding to the target account to request confirmation by the client. The server can send the confirmation request message carrying the verification graph to the client by using a computer network or a communications network, in certain embodiments.

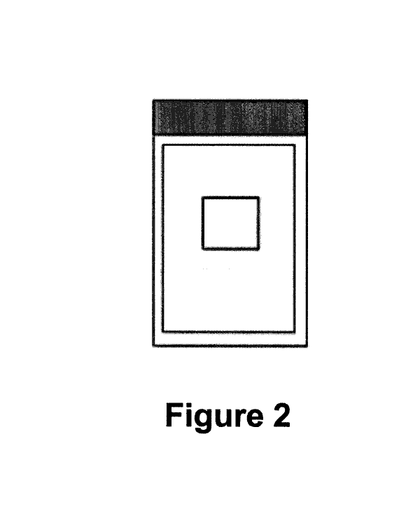

According to another embodiment, during the process S102, the client, upon receiving the confirmation request message, calls and displays a graphic input interface, and displays the verification graph contained in the confirmation request message. For example, upon receiving the confirmation request message, the client parses the confirmation request message based on one or more server-related decoding rules to obtain the corresponding verification graph. For example, the graphic input interface may include a preconfigured user interface. The verification graph obtained by the client can be directly displayed on the graphic input interface, as shown in FIG. 2.

FIG. 2 is a simplified diagram showing a graphic input interface for displaying a verification graph according to one embodiment of the present invention. The diagram is merely an example, which should not unduly limit the scope of the claims. One of ordinary skill in the art would recognize many variations, alternatives, and modifications. For example, the graphic input interface can obtain one or more first graphs that a user inputs by using the user's finger or an input tool (e.g., a touch pen).

Referring back to FIG. 1, during the process S103, the client obtains a first graph input on the graphic input interface and, if the first graph matches with the verification graph, returns a confirmation response message to the server, in some embodiments. For example, the client can obtain the first graph that a user inputs on the graphic input interface based on slide-path identification on a touch screen. As an example, when the user presses the “Confirm” button after completing drawing the first graph, the client can use the identified slide paths as the first graph. As another example, the client uses the slide paths obtained in real time as the first graph and calculates the similarity between the first graph with the verification graph, until the calculation indicates that the first graph matches with the verification graph or until a long time period has passed. The client can use a preconfigured graph-similarity-matching algorithm, for example, a graph similarity algorithm based on characteristics. As an example, the client can compare the characteristics of the first graph with those of the verification graph, and determine whether the first graph matches with the verification graph based on the similarity between them. If the similarity between the two graphs exceeds a threshold, the client determines that the first graph matches with the verification graph. Upon detecting that the obtained first graph matches with the verification graph, the client returns a confirmation response message to the server using a corresponding computer network or a communications network, in some embodiments.

According to one embodiment, during the process S104, upon the receipt of the confirmation response message, the server confirms the event to be confirmed and responds to one or more operations of the target account. For example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and/or responding to a download operation to start data transfer.

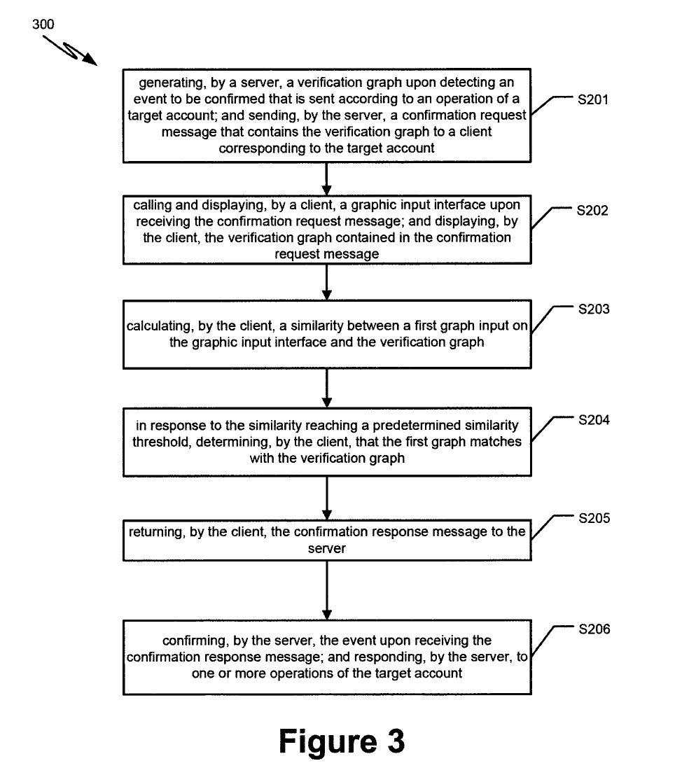

FIG. 3 is a simplified diagram showing a method for confirmation processing according to another embodiment of the present invention. The diagram is merely an example, which should not unduly limit the scope of the claims. One of ordinary skill in the art would recognize many variations, alternatives, and modifications. The method 300 includes at least processes S201-S206.

According to some embodiments, the method 300 is used between a client and a server for certain scenarios in which operations such as payments, purchases, and downloads can be performed upon user confirmation. For example, on the client, one or more confirmation applications can be configured to implement the corresponding functions. As an example, the server generates a verification graph, and the client calculates and confirms graph similarity matching.

According to one embodiment, during the process S201, the server, upon detecting an event to be confunied that is sent according to an operation of the target account, generates a verification graph and sends a confirmation request message that contains the verification graph to the client corresponding to the target account. For example, upon detecting that an operation of a target account needs to be confirmed by the corresponding terminal user, the server detects an event to be confirmed. As an example, when a user needs to be asked to confirm an account transfer operation after initiating a series of payment operations by using his or her payment account, an event to be confirmed by the user has occurred. The generated verification graph can be a geometric graph, a numerical graph, a character graph, and/or a combination thereof. As another example, upon detecting an event to be confirmed, the server randomly generates a simple geometric graph, a numerical graph, and/or a character graph as the verification graph. Then, the server encodes the verification graph and sends a confirmation request message carrying the graph to the client corresponding to the target account to request confirmation by the client, in some embodiments. The server can send the confirmation request message carrying the verification graph to the client by using a computer network or a communications network.

According to another embodiment, during the process S202, the client, upon receiving the confirmation request message, calls and displays a graphic input interface, and displays the verification graph contained in the confirmation request message. For example, the verification graph can be directly displayed on the graphic input interface, e.g., as shown in FIG. 2. According to yet another embodiment, during the process S203, the client calculates the similarity between the first graph currently input on the graphic input interface and the verification graph contained in the confirmation request message. Specifically, one or more graph-similarity-matching algorithms, for example, a graph similarity algorithm based on characteristics, can be preconfigured to calculate the similarity between the first graph and the verification graph.

In one embodiment, the process S203 includes: the client obtains the first graph input on the graphic input interface, and upon detecting completion of graph drawing, the client calls the preconfigured graph-similarity-matching algorithm to calculate the similarity between the first graph and the verification graph contained in the confirmation request message. That is, when the user presses the “Confirm” button after the completion of drawing the first graph, the slide paths identified on the touch-screen are determined as the first graph and subsequent calculation is performed.

In another embodiment, the process S203 includes: the client obtains in real time the first graph input on the graphic input interface, and the client calls the preconfigured graph-similarity-matching algorithm to calculate the similarity between the first graph obtained in real time and the verification graph contained in the confirmation request message. That is, the slide paths already input by the user is used in real time as the first graph for calculating the similarity with the verification graph, until the calculation indicates that the first graph matches with the verification graph or until a long time period has passed.

In yet another embodiment, the process S204 includes: if the calculated similarity value exceeds a predetermined similarity threshold, the client determines that the first graph matches with the verification graph. For example, during the process S205, the client returns a confirmation response message to the server. In another example, upon detecting that the obtained first graph matches with the verification graph, the client determines that the user has confirmed the current operation and returns a confirmation response message to the server by using a computer network or a communications network so that the server executes the corresponding operation in response. The processes S203-S205 correspond to the processes S103, in certain embodiments.

According to one embodiment, during the process S206, upon the receipt of the confirmation response message, the server confirms the event to be confirmed and responds to one or more operations of the target account. For example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and/or responding to a download operation to start data transfer.

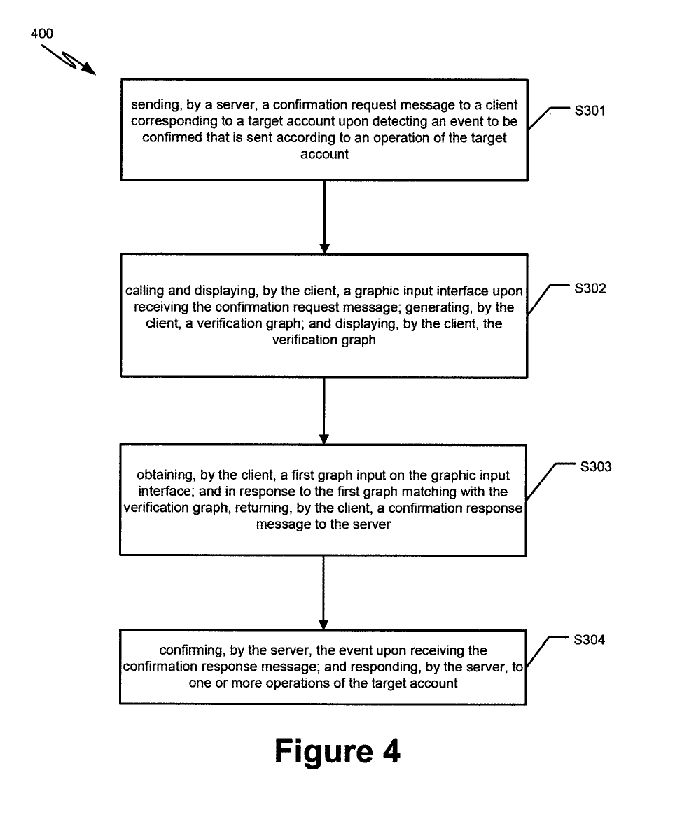

FIG. 4 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 400 includes at least processes S301-S304.

According to some embodiments, the method 400 is used between a client and a server for certain scenarios in which operations such as payments, purchases, and downloads can be performed upon user confirmation. For example, on the client, one or more confirmation applications can be configured to implement the corresponding functions. As an example, the client generates a verification graph, calculates and confirms graph similarity matching.

According to one embodiment, during the process S301, a server, upon detecting an event to be confirmed that is sent according to an operation of the target account, sends a confirmation request message to the client corresponding to the target account. As an example, upon detecting that an operation of a target account needs to be confirmed by the corresponding terminal user, the server detects an event to be confirmed. For example, when a user needs to be asked to confirm an account transfer operation after initiating a series of payment operations by using his or her payment account, an event to be confirmed by the user has occurred. The server can send the confirmation request message carrying the verification graph to the client by using a computer network or a communications network.

According to another embodiment, during the process S302, upon receiving the confirmation request message, the client calls and displays a graphic input interface, generates a verification graph, and displays the verification graph. For example, upon receiving the confirmation request message, the client parses the confirmation request message based on server-related decoding rules to obtain the corresponding verification graph. For example, the graphic input interface may include a preconfigured user interface. As an example, the verification graph can be directly displayed on the graphic input interface, e.g., as shown in FIG. 2. For example, the graphic input interface can obtain one or more first graphs that a user inputs by using the user's finger or an input tool (e.g., a touch pen). As an example, the client can randomly generate a simple geometric graph, a numerical graph, and/or character graph as the verification graph displayed to the user, requesting the user to draw an identical or similar graph for confirmation.

According to yet another embodiment, during the process S303, the client obtains the first graph input on the graphic input interface and, if the first graph matches with the verification graph, returns a confirmation response message to the server. For example, the client can obtain the first graphs that a user inputs on the graphic input interface based on the slide path on the existing identification touch-screen. As an example, when the user presses the “Confirm” button after the completion of drawing the first graph, the client can use the identified slide paths as the first graph. As another example, the client uses the slide paths obtained in real time as the first graph and calculates the matching with the verification graph, until the calculation indicates that the first graph matches with the verification graph or until a long time period has passed. The client can use a preconfigured graph-similarity-matching algorithm, for example, a graph similarity algorithm based on characteristics, in some embodiments. For example, the client specifically can compare the characteristics of the first graph with those of the verification graph, and determine whether the first graph matches with the verification graph based on the similarity between them. If the similarity between the two graphs exceeds a threshold, the client determines that the first graph matches with the verification graph. In another example, upon detecting that the obtained first graph matches with the verification graph, the client returns a confirmation response message to the server by using the corresponding computer network or a communications network.

In one embodiment, during the process S304, upon the receipt of the confirmation response message, the server confirms the event to be confirmed and responds to one or more operations of the target account. For example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and/or responding to a download operation to start data transfer.

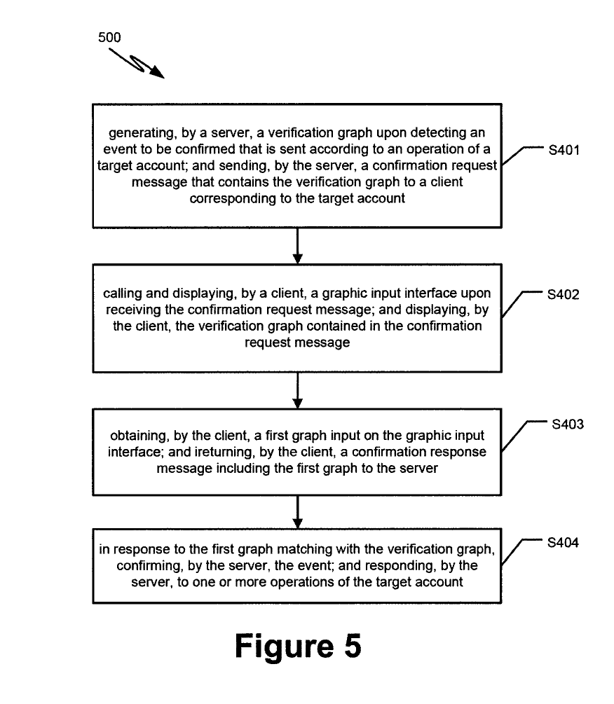

FIG. 5 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 500 includes at least processes S401-S404.

According to some embodiments, the method 500 is used between a client and a server for certain scenarios in which operations such as payments, purchases, and downloads can be performed upon user confirmation. For example, on the client, one or more confirmation applications can be configured to implement the corresponding functions. As an example, the server generates a verification graph, calculates and confirms graph similarity matching between the verification graph and a first graph from the client.

According to one embodiment, during the process S401, the server, upon detecting an event to be confirmed that is sent according to an operation of the target account, generates a verification graph and sends a confirmation request message that contains the verification graph to the client corresponding to the target account. As an example, upon detecting that an operation of a target account needs to be confirmed by the corresponding terminal user, the server detects an event to be confirmed. For example, when a user needs to be asked to confirm an account transfer operation after initiating a series of payment operations by using his or her payment account, an event to be confirmed by the user has occurred. For example, upon detecting an event to be confirmed, the server randomly generates a simple geometric graph, a numerical graph, and/or character graph as the verification graph. Then, the server encodes the verification graph and sends a confirmation request message carrying the graph to the client corresponding to the target account to request confirmation by the client. The server can send the confirmation request message carrying the verification graph to the client by using a computer network or a communications network.

According to another embodiment, during the process S402, the client, upon receiving the confirmation request message, calls and displays a graphic input interface, and displays the verification graph contained in the confirmation request message. For example, during the process S403, the client obtains the first graph input on the graphic input interface and returns to the server a confirmation response message containing the first graph. As an example, upon receiving the confirmation request message, the client parses the confirmation request message based on server-related decoding rules to obtain the corresponding verification graph. For example, the graphic input interface may include a preconfigured user interface. For example, the verification graph can be directly displayed on the graphic input interface, e.g., as shown in FIG. 2. For example, the graphic input interface can obtain one or more first graphs that a user inputs by using the user's finger or an input tool (e.g., a touch pen). The client can obtain the first graphs that a user inputs on the graphic input interface based on the slide paths on the existing identification touch-screen. For example, when the user presses the “Confirm” button after the completion of drawing the first graph, the client can use the identified slide paths as the first graph. The client returns a confirmation response message to the server by using a corresponding computer network or a communications network.

According to yet another embodiment, during the process S404, if the first graph in the confirmation response message matches with the verification graph, the server confirms the event to be confirmed and responds to the operations of the target account. For example, upon receiving from the client a confirmation response message containing the first graph, the server specifically can compare the characteristics of the first graph with those of the verification graph, and determine whether the first graph matches with the verification graph based on the similarity between them. If the similarity between the two graphs exceeds a threshold, the server determines that the first graph matches with the verification graph. For example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and/or responding to a download operation to start data transfer.

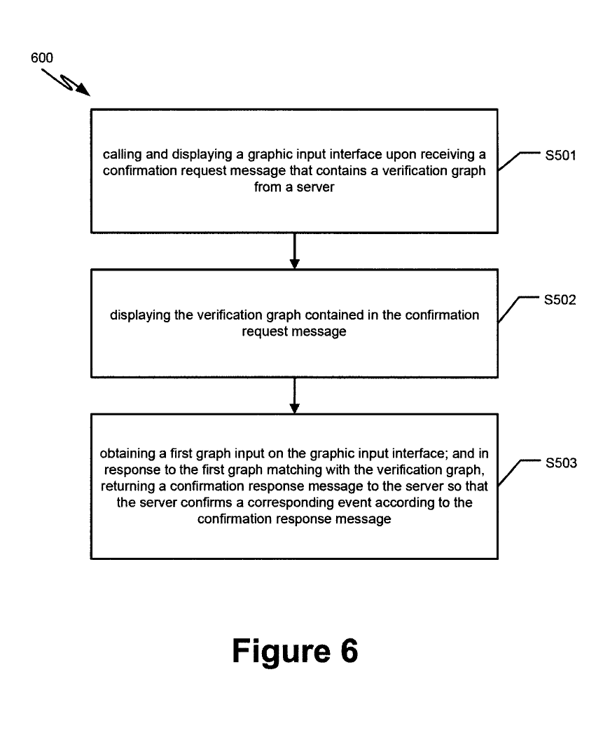

FIG. 6 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 600 includes at least processes S501-S503.

According to some embodiments, the method 600 is used on a client for certain scenarios in which operations such as payments, purchases, and downloads can be performed upon user confirmation. For example, on the client, one or more confirmation applications can be configured to implement the corresponding functions.

According to one embodiment, during the process S501, upon receiving from the server a confirmation request message that contains a verification graph, a graphic input interface is called and displayed. For example, during the process S502, the verification graph contained in the confirmation request message is displayed. As an example, upon receiving the confirmation request message, the client parses the confirmation request message based on server-related decoding rules to obtain the corresponding verification graph. For example, the graphic input interface may include a preconfigured user interface. As an example, the verification graph obtained by the client can be directly displayed on the graphic input interface. For example, the graphic input interface can obtain one or more first graphs that a user inputs by using the user's finger or an input tool (e.g., a touch pen).

According to another embodiment, during the process S503, the first graph input on the graphic input interface is obtained. For example, if the first graph matches with the verification graph, a confirmation response message is returned to the server so that the server confirms the corresponding event to be confirmed according to the confirmation response message. In another example, the client can obtain the first graphs that a user inputs on the graphic input interface based on the slide path on the existing identification touch-screen. As an example, when the user presses the “Confirm” button after the completion of drawing the first graph, the client can use the identified slide paths as the first graph. As another example, the client uses the slide paths obtained in real time as the first graph and calculates the matching with the verification graph, until the calculation indicates that the first graph matches with the verification graph or until a long time period has passed. The client can use a preconfigured graph-similarity-matching algorithm, for example, a graph similarity algorithm based on characteristics, in some embodiments. For example, the client specifically can compare the characteristics of the first graph with those of the verification graph, and determine whether the first graph matches with the verification graph based on the similarity between them. If the similarity between the two graphs exceeds a threshold, the client determines that the first graph matches with the verification graph. In another example, upon detecting that the obtained first graph matches with the verification graph, the client returns a confirmation response message to the server by using the corresponding computer network or a communications network.

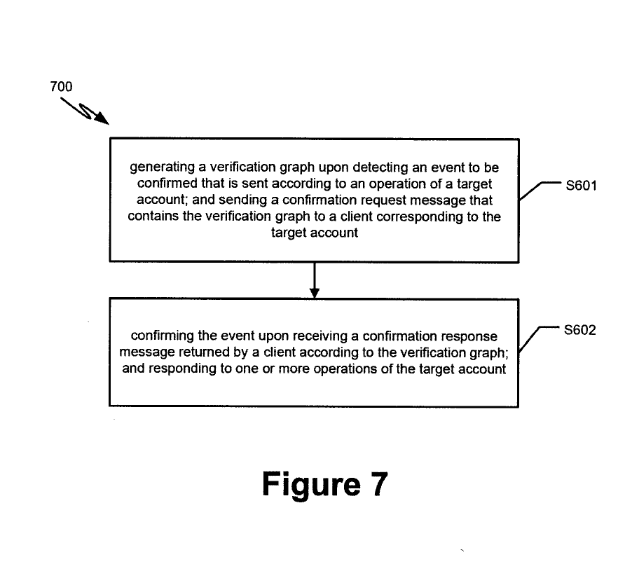

FIG. 7 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 700 includes at least processes S601-S602. According to some embodiments, the method 700 is used on a server.

According to one embodiment, the process S601 include, the server, upon detecting an event to be confirmed that is sent according to an operation of the target account, generates a verification graph and sends a confirmation request message that contains the verification graph to the client corresponding to the target account. As an example, upon detecting that an operation of a target account needs to be confirmed by the corresponding terminal user, the server detects an event to be confirmed. For example, when a user needs to be asked to confirm an account transfer operation after initiating a series of payment operations by using his or her payment account, an event to be confirmed by the user has occurred. In another example, upon detecting an event to be confirmed, the server randomly generates a simple geometric graph, a numerical graph, and/or character graph as the verification graph. Then, the server encodes the verification graph and sends a confirmation request message carrying the graph to the client corresponding to the target account to request confirmation by the client. The server can send the confirmation request message carrying the verification graph to the client by using a computer network or a communications network.

According to another embodiment, during the process S602, if a confirmation response message is received from the client according to the verification graph, the event to be confirmed is confirmed and a response given to the operation of the target account. For example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and responding to a download operation to start data transfer. In some embodiments, the process of the client's returning a confirmation response message is the same as shown in FIG. 1, FIG. 2, FIG. 3, and/or FIG. 4.

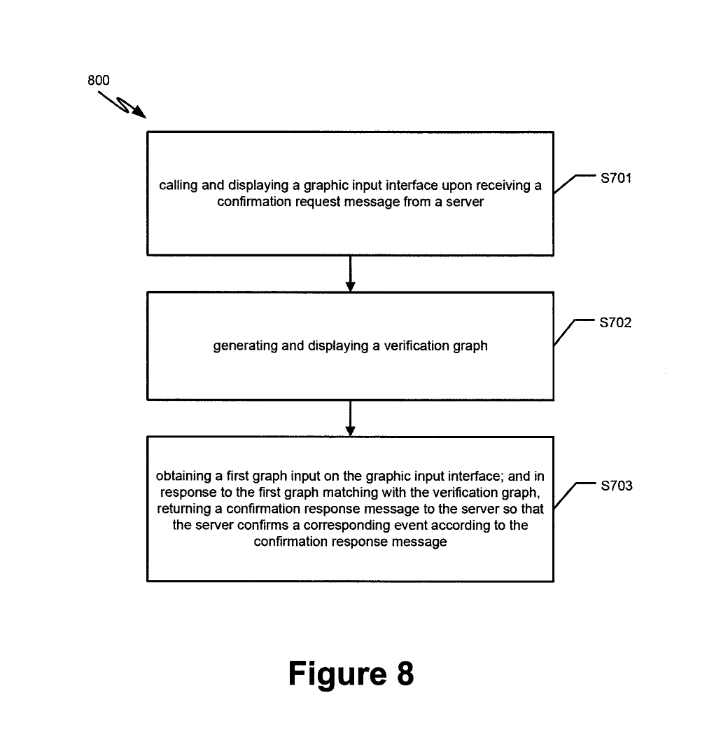

FIG. 8 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 800 includes at least processes S701-S703.

According to some embodiments, the method 800 is used on a client for certain scenarios in which operations such as payments, purchases, and downloads can be performed upon user confirmation. For example, on the client, one or more confirmation applications can be configured to implement the corresponding functions.

According to one embodiment, during the process S701, upon receiving a confirmation request message from the server, a graphic input interface is called and displayed. For example, the graphic input interface may include a preconfigured user interface. As an example, the verification graph obtained by the client can be directly displayed on the graphic input interface, as shown in FIG. 2. For example, the graphic input interface can obtain one or more first graphs that a user inputs by using the user's finger or an input tool (e.g., a touch pen).

According to another embodiment, during the process S702, a verification graph is generated and the verification graph is displayed. The verification graph can be a simple geometric graph, a numerical graph, or a character graph randomly generated by the client. For example, during the process S703, the first graph input on the graphic input interface is obtained. If the first graph matches with the verification graph, a confirmation response message is returned to the server so that the server confirms the corresponding event to be confirmed according to the confirmation response message. As an example, the client can obtain the first graphs that a user inputs on the graphic input interface based on the slide path on the existing identification touch-screen. When the user presses the “Confirm” button after the completion of drawing the first graph, the client can use the identified slide path as the first graph. As another example, the client uses the slide path obtained in real time as the first graph and calculates the matching with the verification graph, until the calculation indicates that the first graph matches with the verification graph or until a long time period has passed. The client can use a preconfigured graph-similarity-matching algorithm, for example, a graph similarity algorithm based on characteristics. In another example, the client specifically can compare the characteristics of the first graph with those of the verification graph, and determine whether the first graph matches with the verification graph based on the similarity between them. If the similarity between the two graphs exceeds a threshold, the client determines that the first graph matches with the verification graph. For example, upon detecting that the obtained first graph matches with the verification graph, the client returns a confirmation response message to the server by using the corresponding computer network or a communications network.

According to yet another embodiment, the process S701 includes: the client calculates the similarity between the first graph currently input on the graphic input interface and the verification graph contained in the confirmation request message; if the calculated similarity value exceeds the predetermined similarity threshold, the client determines that the first graph matches with the verification graph; the client returns a confirmation response message to the server. For example, the calculation of the similarity between the first graph currently input on the graphic input interface and the verification graph contained in the confirmation request message includes: obtaining the first graph input on the graphic input interface; upon detecting completion of graph drawing, calling the predetermined similarity algorithm to calculate the similarity between the first graph and the verification graph contained in the confirmation request message. In another example, the calculation of the similarity between the first graph currently input on the graphic input interface and the verification graph contained in the confirmation request message includes: obtaining in real time the first graph currently input on the graphic input interface; calling the preconfigured graph-similarity-matching algorithm to calculate the similarity between the first graph obtained in real time and the verification graph contained in the confirmation request message.

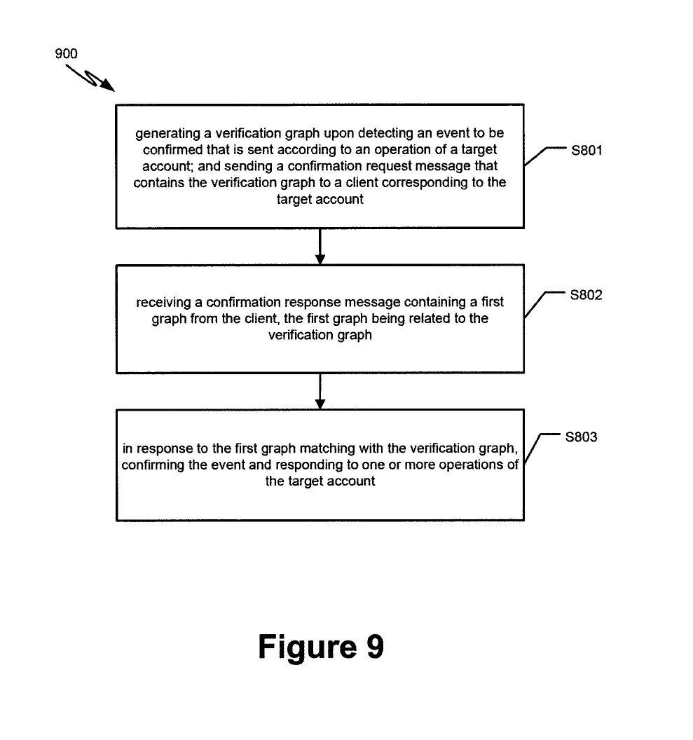

FIG. 9 is a simplified diagram showing a method for confirmation processing according to yet another embodiment of the present invention. The diagram is merely an example, which should not unduly limit the scope of the claims. One of ordinary skill in the art would recognize many variations, alternatives, and modifications. The method 900 includes at least processes S801-S803. The method 900 is implemented on a server, in some embodiments.

According to one embodiment, during the process S801, the server, upon detecting an event to be confirmed that is sent according to an operation of the target account, generates a verification graph and sends a confirmation request message that contains the verification graph to the client corresponding to the target account. For example, upon detecting that an operation of a target account needs to be confirmed by the corresponding terminal user, the server detects an event to be confirmed. In another example, when a user needs to be asked to confirm an account transfer operation after initiating a series of payment operations by using his or her payment account, an event to be confirmed by the user has occurred. For example, upon detecting an event to be confirmed, the server randomly generates a simple geometric graph, a numerical graph, and/or character graph as the verification graph. Then, the server encodes the verification graph and sends a confirmation request message carrying the graph to the client corresponding to the target account to request confirmation by the client. The server can send the confirmation request message carrying the verification graph to the client by using a computer network or a communications network.

According to another embodiment, during the process S802, a confirmation response message is received from the client. For example, the confirmation response message contains the first graph that the client obtains according to the verification graph. The first graph contained in the confirmation response message returned by the client can be a user-drawn graph that the client obtains based on the graphic input interface after receiving the verification graph.

According to yet another embodiment, during the process S803, if the first graph in the confirmation response message matches with the verification graph, the event to be confirmed is confirmed and a response is given to the operation of the target account. The server can use a preconfigured graph-similarity-matching algorithm, for example, a graph similarity algorithm based on characteristics. As an example, the server specifically can compare the characteristics of the first graph with those of the verification graph, and determine whether the first graph matches with the verification graph based on the similarity between them. If the similarity between the two graphs exceeds a threshold, the client determines that the first graph matches with the verification graph.

In one embodiment, in the process S803, confirmation of whether the first graph matches with the verification graph includes: the similarity between the first graph in the confirmation response message and the verification graph is calculated; if the calculated similarity value exceeds the predetermined similarity threshold, it is determined that the first graph matches with the verification graph. For example, the client calculates the similarity between the first graph contained in the confirmation response message and the verification graph, comprising: parsing the confirmation response message to obtain the first graph contained in it; calling the predetermined similarity algorithm to calculate the similarity between the first graph and the verification graph contained in the confirmation request message. In another example, upon receiving the confirmation response message, the server can determine that the user has confirmed the current operation. The server gives a response to the corresponding operation, for example, responding to a payment operation to initiate the account transfer procedure, confirming a purchase operation to initiate the payment procedure, and responding to a download operation to start data transfer.

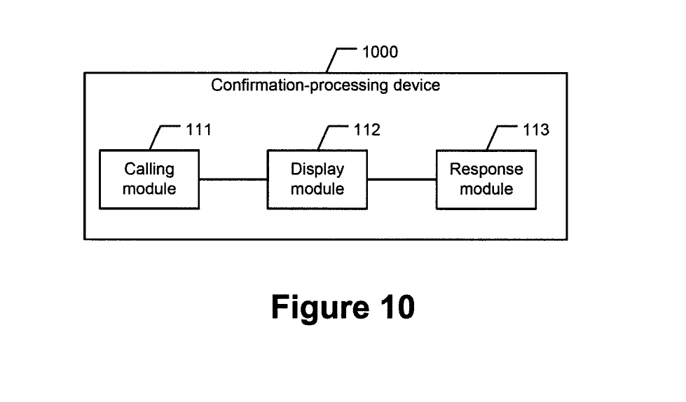

FIG. 10 is a simplified diagram showing a device for confirmation processing according to one embodiment of the present invention. The diagram is merely an example, which should not unduly limit the scope of the claims. One of ordinary skill in the art would recognize many variations, alternatives, and modifications.

According to some embodiments, the device 1000 can be configured on a user terminal, for example, a mobile smart device with network capabilities (e.g., a tablet computer, a mobile phone, an electronic reader, a remote controller, a vehicle-mounted device, and a wearable device). For example, the device 1000 includes: a calling module 111 configured to call and display a graphic input interface upon receipt of a confirmation request message containing a verification graph from a server; a display module 112 configured to display the verification graph contained in the confirmation request message; and a response module 113 configured to obtain a first graph input on the graphic input interface, and in response to the first graph matching with the verification graph, return a confirmation response message to the server so that the server confirms a corresponding event according to the confirmation response message. The calling module 111, the display module 112, and the response module 113 are implemented to perform the processes S501-S503 as shown in FIG. 6, according to certain embodiments.

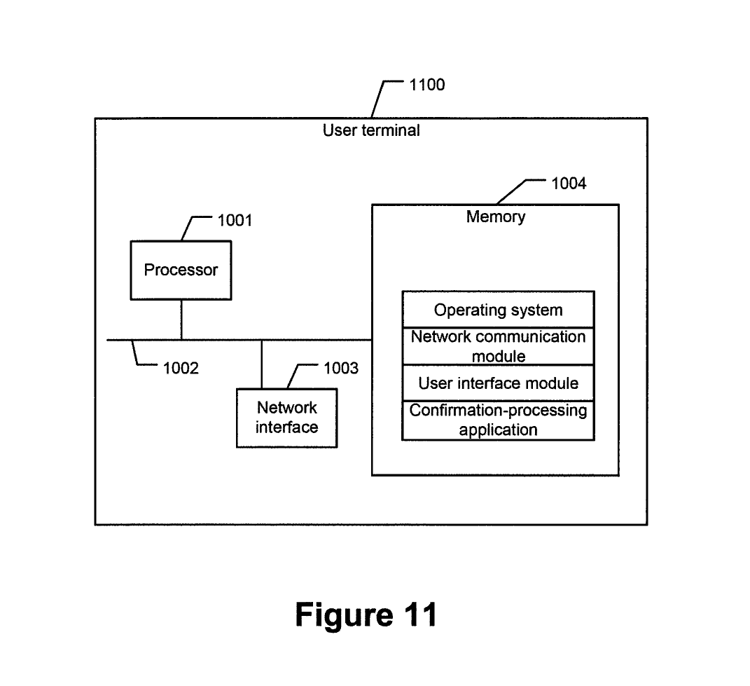

FIG. 11 is a simplified diagram showing a user terminal for confirmation processing according to one embodiment of the present invention. The diagram is merely an example, which should not unduly limit the scope of the claims. One of ordinary skill in the art would recognize many variations, alternatives, and modifications. The user terminal 1100 includes one or more processors 1001 (e.g., a CPU), a communication bus 1002, a network interface 1003, and a memory 1004.

According to one embodiment, the communication bus 1002 is configured to implement interconnection and communication between other components of the user terminal 1100. For example, the network interface 1003 includes a standard wired interface and/or a wireless interface (e.g., a WIFI interface, a mobile communications interface). The memory 1004 includes a high-speed RAM and/or a nonvolatile memory (e.g., a disk storage module). As an example, the memory 1004 includes a storage device far away from the processor 1001. As shown in FIG. 11, the memory 1004 (e.g., a computer storage medium) stores an operating system, a network communications module, and/or one or more confirmation-processing applications (e.g., programs for payments), in some embodiments.

According to another embodiment, the processor 1001 is configured to call the confirmation-processing applications (e.g., programs for payments) stored in the memory 1004, and execute the following operations: calling and displaying a graphic input interface upon receiving from the server a confirmation request message that contains a verification graph; displaying the verification graph contained in the confirmation request message; obtaining the first graph input on the graphic input interface and, if the first graph matches with the verification graph, returning a confirmation response message to the server so that the server confirms the corresponding event to be confirmed according to the confirmation response message.

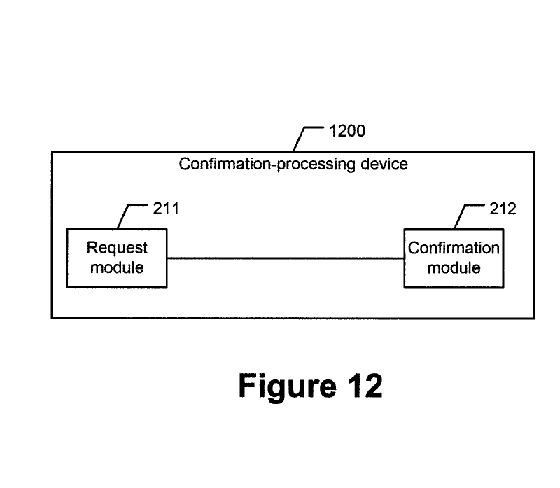

FIG. 12 is a simplified diagram showing a device for confirmation processing according to another embodiment of the present invention. The diagram is merely an example, which should not unduly limit the scope of the claims. One of ordinary skill in the art would recognize many variations, alternatives, and modifications.

The device 1200 is implemented on one or more servers, in some embodiments. For example, the device 1200 includes: a request module 211 configured to generate a verification graph upon detecting an event to be confirmed that is sent according to an operation of a target account and send a confirmation request message that contains the verification graph to a client corresponding to the target account; a confirmation module 212 configured to confirm the event upon receiving a confirmation response message returned by a client according to the verification graph and respond to one or more operations of the target account. The request module 211 and the confirmation module 212 are implemented to perform the processes S601-S602 as shown in FIG. 7, according to certain embodiments.

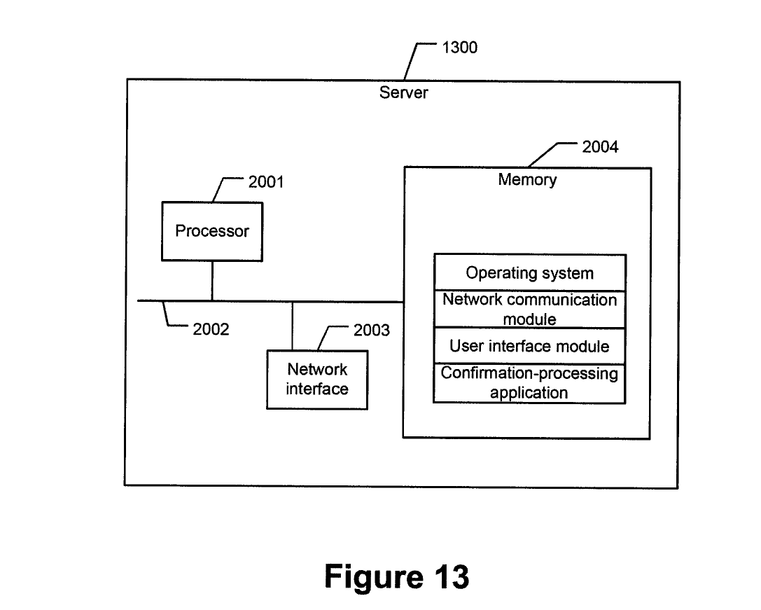

FIG. 13 is a simplified diagram showing a server for confirmation processing according to one embodiment of the present invention. The diagram is merely an example, which should not unduly limit the scope of the claims. One of ordinary skill in the art would recognize many variations, alternatives, and modifications. The server 1300 includes one or more processors 2001 (e.g., a CPU), a communication bus 2002, a network interface 2003, and a memory 2004.

According to one embodiment, the communication bus 2002 is configured to implement interconnection and communication between other components of the server 1300. For example, the network interface 2003 includes a standard wired interface and/or a wireless interface (e.g., a WIFI interface, a mobile communications interface). The memory 2004 includes a high-speed RAM and/or a nonvolatile memory (e.g., a disk storage module). As an example, the memory 2004 includes a storage device far away from the processor 2001. As shown in FIG. 13, the memory 2004 (e.g., a computer storage medium) stores an operating system, a network communications module, and/or one or more confirmation-processing applications (e.g., programs for payments), in some embodiments.

According to another embodiment, the processor 2001 is configured to call the confirmation-processing applications (e.g., programs for payments) stored in the memory 2004, and execute the following operations: the server, upon detecting an event to be confirmed that is sent according to an operation of the target account, generates a verification graph and sends a confirmation request message that contains the verification graph to the client corresponding to the target account; if a confirmation response message is received from the client according to the verification graph, the event to be confirmed is confirmed and a response given to the operation of the target account.

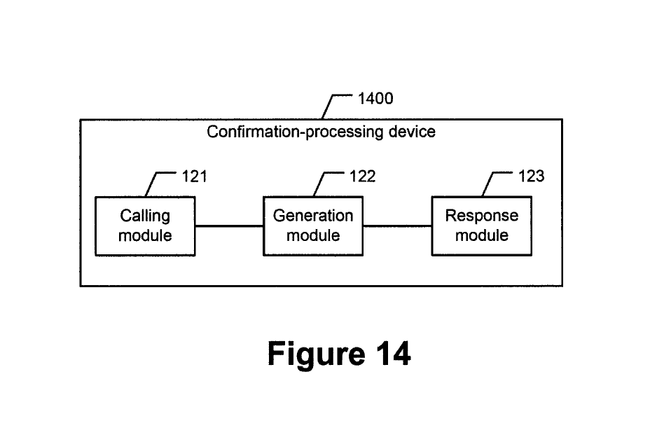

FIG. 14 is a simplified diagram showing a device for confirmation processing according to yet another embodiment of the present invention. The diagram is merely an example, which should not unduly limit the scope of the claims. One of ordinary skill in the art would recognize many variations, alternatives, and modifications.

According to some embodiments, the device 1400 can be configured on a user terminal, for example, a mobile smart device with network capabilities (e.g., a tablet computer, a mobile phone, an electronic reader, a remote controller, a vehicle-mounted device, and a wearable device). For example, the device 1400 includes: a calling module 121 configured to call and display a graphic input interface upon receiving a confirmation request message from a server; a generation module 122 configured to configured to generate and display a verification graph; and a response module 123 configured to obtain a first graph input on the graphic input interface, and in response to the first graph matching with the verification graph, return a confirmation response message to the server so that the server confirms a corresponding event according to the confirmation response message. The calling module 121, the generation module 122, and the response module 123 are implemented to perform the processes S701-S703 as shown in FIG. 8, according to certain embodiments.

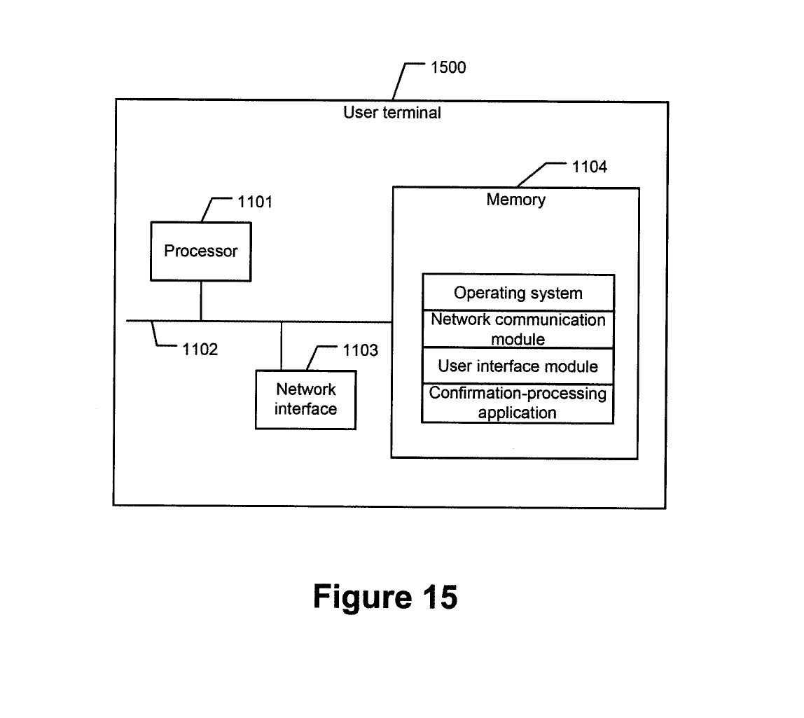

FIG. 15 is a simplified diagram showing a user terminal for confirmation processing according to another embodiment of the present invention. The diagram is merely an example, which should not unduly limit the scope of the claims. One of ordinary skill in the art would recognize many variations, alternatives, and modifications. The user terminal 1500 includes one or more processors 1101 (e.g., a CPU), a communication bus 1102, a network interface 1103, and a memory 1104.

According to one embodiment, the communication bus 1102 is configured to implement interconnection and communication between other components of the user terminal 1500. For example, the network interface 1103 includes a standard wired interface and/or a wireless interface (e.g., a WIFI interface, a mobile communications interface). The memory 1104 includes a high-speed RAM and/or a nonvolatile memory (e.g., a disk storage module). As an example, the memory 1104 includes a storage device far away from the processor 1101. As shown in FIG. 15, the memory 1104 (e.g., a computer storage medium) stores an operating system, a network communications module, and/or one or more confirmation-processing applications (e.g., programs for payments), in some embodiments.

According to another embodiment, the processor 1101 is configured to call the confirmation-processing applications (e.g., programs for payments) stored in the memory 1104, and execute the following operations: calling and displaying a graphic input interface upon receiving a confirmation request message from the server; generating a verification graph and displaying the verification graph; obtaining the first graph input on the graphic input interface and, if the first graph matches with the verification graph, returning a confirmation response message to the server so that the server confirms the corresponding event to be confirmed according to the confirmation response message.

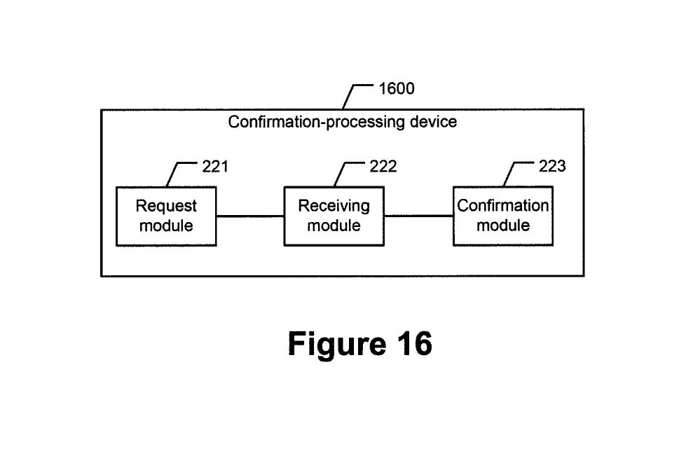

FIG. 16 is a simplified diagram showing a device for confirmation processing according to yet another embodiment of the present invention. The diagram is merely an example, which should not unduly limit the scope of the claims. One of ordinary skill in the art would recognize many variations, alternatives, and modifications.

The device 1600 is implemented on one or more servers, in some embodiments. For example, the device 1600 includes: a request module 221 configured to generate a verification graph upon detecting an event to be confirmed that is sent according to an operation of a target account and send a confirmation request message that contains the verification graph to a client corresponding to the target account; a receiving module 222 configured to receive a confirmation response message containing a first graph from the client, the first graph being related to the verification graph; and a confirmation module 223 configured to confirm the event upon receiving a confirmation response message returned by a client according to the verification graph and respond to one or more operations of the target account. The request module 221, the receiving module 222, and the confirmation module 223 are implemented to perform the processes S801-S803 as shown in FIG. 9, according to certain embodiments.

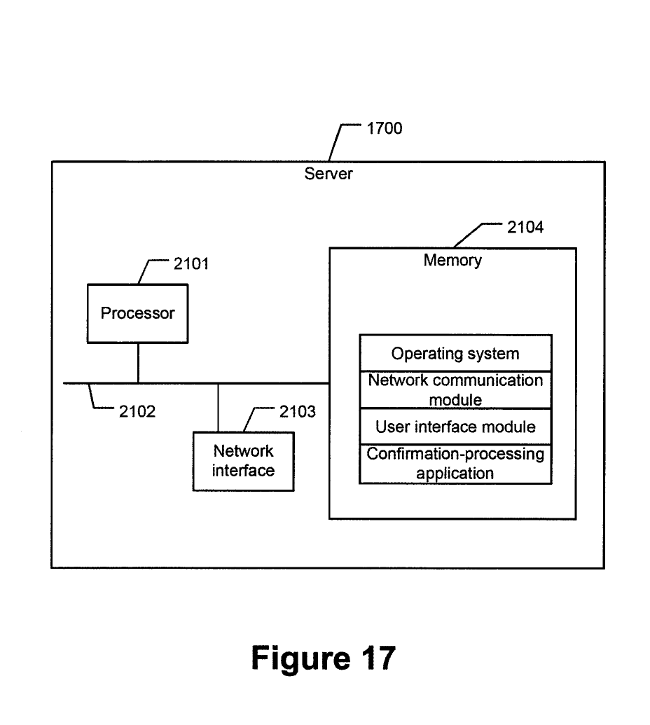

FIG. 17 is a simplified diagram showing a server for confirmation processing according to another embodiment of the present invention. The diagram is merely an example, which should not unduly limit the scope of the claims. One of ordinary skill in the art would recognize many variations, alternatives, and modifications. The server 1700 includes one or more processors 2101 (e.g., a CPU), a communication bus 2102, a network interface 2103, and a memory 2104.

According to one embodiment, the communication bus 2102 is configured to implement interconnection and communication between other components of the server 1700. For example, the network interface 2103 includes a standard wired interface and/or a wireless interface (e.g., a WIFI interface, a mobile communications interface). The memory 2104 includes a high-speed RAM and/or a nonvolatile memory (e.g., a disk storage module). As an example, the memory 2104 includes a storage device far away from the processor 2101. As shown in FIG. 17, the memory 2104 (e.g., a computer storage medium) stores an operating system, a network communications module, and/or one or more confirmation-processing applications (e.g., programs for payments), in some embodiments.

According to another embodiment, the processor 2101 is configured to call the confirmation-processing applications (e.g., programs for payments) stored in the memory 2104, and execute the following operations: the server, upon detecting an event to be confirmed that is sent according to an operation of the target account, generates a verification graph and sends a confirmation request message that contains the verification graph to the client corresponding to the target account; a confirmation response message is received from the client, containing the first graph that the client obtains according to the verification graph; and if the first graph in the confirmation response message matches with the verification graph, the event to be confirmed is confirmed and a response is given to the operation of the target account.

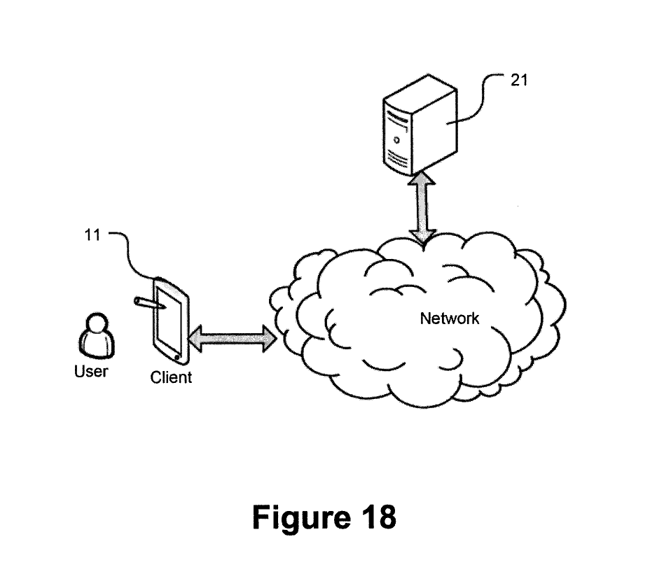

FIG. 18 is a simplified diagram showing a confirmation-processing system according to one embodiment of the present invention. The diagram is merely an example, which should not unduly limit the scope of the claims. One of ordinary skill in the art would recognize many variations, alternatives, and modifications. The confirmation-processing system includes a client 11 and a server 21.

According to one embodiment, the server 21 is configured to generate a verification graph upon detecting an event to be confirmed that is sent according to an operation of a target account and send a confirmation request message that contains the verification graph to the client 11 corresponding to the target account. For example, the client 11 is configured to call and display a graphic input interface upon receiving the confirmation request message and display the verification graph contained in the confirmation request message. As an example, the client 11 is further configured to obtain a first graph input on the graphic input interface, and in response to the first graph matching with the verification graph, return a confirmation response message to the server 21. In one example, the server 21 is further configured to confirm the event and respond to one or more operations of the target account.

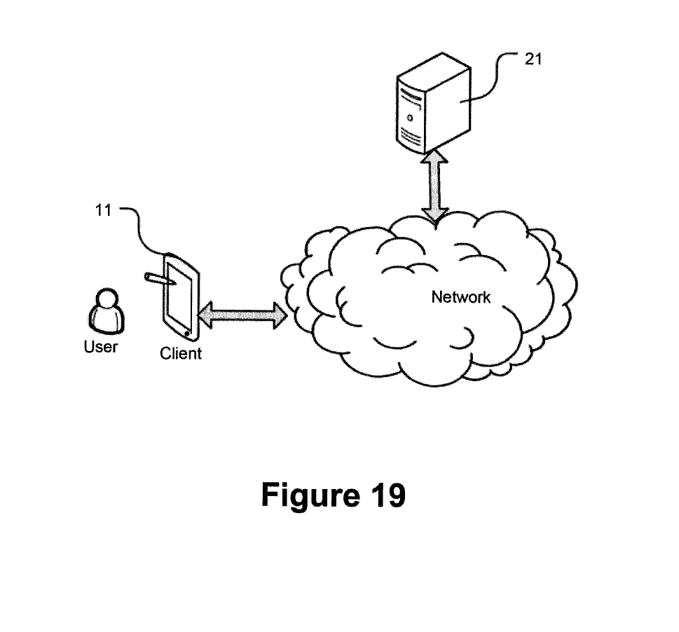

FIG. 19 is a simplified diagram showing a confirmation-processing system according to another embodiment of the present invention. The diagram is merely an example, which should not unduly limit the scope of the claims. One of ordinary skill in the art would recognize many variations, alternatives, and modifications. The confirmation-processing system includes a client 11 and a server 21.

According to one embodiment, the server 21 is configured to send a confirmation request message to the client 11 corresponding to a target account upon detecting an event to be confirmed that is sent according to an operation of the target account. For example, the client 11 is configured to call and display a graphic input interface upon receiving the confirmation request message, and generate and display a verification graph. In another example, the client 11 is further configured to obtain a first graph input on the graphic input interface, and in response to the first graph matching with the verification graph, return a confirmation response message to the server 21. In yet another example, the server 21 is further configured to confirm the event upon receiving the confirmation response message and respond to one or more operations of the target account.

According to one embodiment, a method is provided for confirmation processing. For example, a server generates a verification graph upon detecting an event to be confirmed that is sent according to an operation of a target account; the server sends a confirmation request message that contains the verification graph to a client corresponding to the target account; a client calls and displays a graphic input interface upon receiving the confirmation request message; the client displays the verification graph contained in the confirmation request message; the client obtains a first graph input on the graphic input interface; in response to the first graph matching with the verification graph, the client returns a confirmation response message to the server; the server confirms the event upon receiving the confirmation response message; and the server responds to one or more operations of the target account. For example, the method is implemented according to at least FIG. 1.

According to another embodiment, a method is provided for confirmation processing. For example, a server sends a confirmation request message to a client corresponding to a target account upon detecting an event to be confirmed that is sent according to an operation of the target account; the client calls a graphic input interface upon receiving the confirmation request message; the client displays the graphic input interface; the client generates and displays a verification graph; the client obtains a first graph input on the graphic input interface; in response to the first graph matching with the verification graph, the client returns a confirmation response message to the server; the server confirms the event upon receiving the confirmation response message; and the server responds to one or more operations of the target account. For example, the method is implemented according to at least FIG. 4.

According to yet another embodiment, a method is provided for confirmation processing. For example, a server generates a verification graph upon detecting an event to be confirmed that is sent according to an operation of a target account; the server sends a confirmation request message that contains the verification graph to a client corresponding to the target account; a client calls and displays a graphic input interface upon receiving the confirmation request message; the client displays the verification graph contained in the confirmation request message; the client obtains a first graph input on the graphic input interface; the client returns a confirmation response message containing the first graph to the server; in response to the first graph matching with the verification graph, the server confirms the event responds to one or more operations of the target account. For example, the method is implemented according to at least FIG. 5.

In one embodiment, a method is provided for confirmation processing. For example, a graphic input interface is called and displayed upon receiving a confirmation request message that contains a verification graph from a server; the verification graph contained in the confirmation request message is displayed; a first graph input on the graphic input interface is obtained; and in response to the first graph matching with the verification graph, a confirmation response message is returned to the server so that the server confirms a corresponding event according to the confirmation response message. For example, the method is implemented according to at least FIG. 6.

In another embodiment, a method is provided for confirmation processing. For example, a verification graph is generated upon detecting an event to be confirmed that is sent according to an operation of a target account; a confirmation request message that contains the verification graph is sent to a client corresponding to the target account; the event is confirmed upon receiving a confirmation response message returned by a client according to the verification graph; and one or more operations of the target account are responded to. For example, the method is implemented according to at least FIG. 7.

In yet another embodiment, a method is provided for confirmation processing. For example, a graphic input interface is called and displayed upon receiving a confirmation request message from a server; a verification graph is generated and displayed; a first graph input on the graphic input interface is obtained; and in response to the first graph matching with the verification graph, a confirmation response message is returned to the server so that the server confirms a corresponding event according to the confirmation response message. For example, the method is implemented according to at least FIG. 8.

According to one embodiment, a method is provided for confirmation processing. For example, a verification graph is generated upon detecting an event to be confirmed that is sent according to an operation of a target account; a confirmation request message that contains the verification graph is sent to a client corresponding to the target account; a confirmation response message containing a first graph is received from the client, the first graph being related to the verification graph; in response to the first graph matching with the verification graph, the event is confinued and one or more operations of the target account are responded to. For example, the method is implemented according to at least FIG. 9.

According to another embodiment, a confirmation-processing device includes: a calling module configured to call and display a graphic input interface upon receipt of a confirmation request message containing a verification graph from a server; a display module configured to display the verification graph contained in the confirmation request message; and a response module configured to obtain a first graph input on the graphic input interface, and in response to the first graph matching with the verification graph, return a confirmation response message to the server so that the server confirms a corresponding event according to the confirmation response message. For example, the device is implemented according to at least FIG. 10.

According to yet another embodiment, a confirmation-processing device includes: a request module configured to generate a verification graph upon detecting an event to be confirmed that is sent according to an operation of a target account and send a confirmation request message that contains the verification graph to a client corresponding to the target account; and a confirmation module configured to confirm the event upon receiving a confirmation response message returned by a client according to the verification graph and respond to one or more operations of the target account. For example, the device is implemented according to at least FIG. 12.

In one embodiment, a confirmation-processing device includes: a calling module configured to call and display a graphic input interface upon receiving a confirmation request message from a server; a generation module configured to generate and display a verification graph; and a response module configured to obtain a first graph input on the graphic input interface, and in response to the first graph matching with the verification graph, return a confirmation response message to the server so that the server confirms a corresponding event according to the confirmation response message. For example, the device is implemented according to at least FIG. 14.

In another embodiment, a confirmation-processing device includes: a request module configured to generate a verification graph upon detecting an event to be confirmed that is sent according to an operation of a target account and send a confirmation request message that contains the verification graph to a client corresponding to the target account; a receiving module configured to receive a confirmation response message containing a first graph from the client, the first graph being related to the verification graph; and a confirmation module configured to, in response to the first graph matching with the verification graph, confirm the event and respond to one or more operations of the target account. For example, the device is implemented according to at least FIG. 16.

In yet another embodiment, a non-transitory computer readable storage medium includes programming instructions for confirmation processing. The programming instructions are configured to cause one or more data processors to execute certain operations. For example, a graphic input interface is called and displayed upon receiving a confirmation request message that contains a verification graph from a server; the verification graph contained in the confirmation request message is displayed; a first graph input on the graphic input interface is obtained; and in response to the first graph matching with the verification graph, a confirmation response message is returned to the server so that the server confirms a corresponding event according to the confirmation response message. For example, the storage medium is implemented according to at least FIG. 6.

According to one embodiment, a non-transitory computer readable storage medium includes programming instructions for confirmation processing. The programming instructions are configured to cause one or more data processors to execute certain operations. For example, a verification graph is generated upon detecting an event to be confirmed that is sent according to an operation of a target account; a confirmation request message that contains the verification graph is sent to a client corresponding to the target account; the event is confirmed upon receiving a confirmation response message returned by a client according to the verification graph; and one or more operations of the target account are responded to. For example, the storage medium is implemented according to at least FIG. 7.

According to another embodiment, a non-transitory computer readable storage medium includes programming instructions for confirmation processing. The programming instructions are configured to cause one or more data processors to execute certain operations. For example, a graphic input interface is called and displayed upon receiving a confirmation request message from a server; a verification graph is generated and displayed; a first graph input on the graphic input interface is obtained; and in response to the first graph matching with the verification graph, a confirmation response message is returned to the server so that the server confirms a corresponding event according to the confirmation response message. For example, the storage medium is implemented according to at least FIG. 8.

According to yet another embodiment, a non-transitory computer readable storage medium includes programming instructions for confirmation processing. The programming instructions are configured to cause one or more data processors to execute certain operations. For example, a verification graph is generated upon detecting an event to be confirmed that is sent according to an operation of a target account; a confirmation request message that contains the verification graph is sent to a client corresponding to the target account; a confirmation response message containing a first graph is received from the client, the first graph being related to the verification graph; in response to the first graph matching with the verification graph, the event is confirmed and one or more operations of the target account are responded to. For example, the storage medium is implemented according to at least FIG. 9.

In one embodiment, a confirmation-processing system includes: a client; and a server. The server is configured to generate a verification graph upon detecting an event to be confirmed that is sent according to an operation of a target account and send a confirmation request message that contains the verification graph to a client corresponding to the target account. The client is configured to call and display a graphic input interface upon receiving the confirmation request message and display the verification graph contained in the confirmation request message. The client is further configured to obtain a first graph input on the graphic input interface, and in response to the first graph matching with the verification graph, return a confirmation response message to the server. The server is further configured to confirm the event and respond to one or more operations of the target account. For example, the system is implemented according to at least FIG. 18.

In another embodiment, a confirmation-processing system includes: a client; and a server. The server is configured to send a confirmation request message to a client corresponding to a target account upon detecting an event to be confirmed that is sent according to an operation of the target account. The client is configured to call and display a graphic input interface upon receiving the confirmation request message, and generate and display a verification graph. The client is further configured to obtain a first graph input on the graphic input interface, and in response to the first graph matching with the verification graph, return a confirmation response message to the server. The server is further configured to confirm the event upon receiving the confirmation response message and respond to one or more operations of the target account. For example, the system is implemented according to at least FIG. 19.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for confirmation processing, the method comprising:
generating, by a server, a verification graph upon detecting an event to be confirmed that is sent according to an operation of a target account;
sending, by the server, a confirmation request message that contains the verification graph to a client corresponding to the target account;
calling, by a client, a graphic input interface upon receiving the confirmation request message;
displaying, by the client, the graphic input interface;
displaying, by the client, the verification graph contained in the confirmation request message;
obtaining, by the client, a first graph input on the graphic input interface;
in response to the first graph matching with the verification graph, returning, by the client, a confirmation response message to the server;
confirming, by the server, the event upon receiving the confirmation response message; and
responding, by the server, to one or more operations of the target account.

2. The method of claim 1, wherein the obtaining, by the client, a first graph input on the graphic input interface and the returning, by the client, a confirmation response message to the server in response to the first graph matching with the verification graph include:
calculating, by the client, a similarity between the first graph and the verification graph;
in response to the similarity reaching a predetermined similarity threshold, determining, by the client, that the first graph matches with the verification graph; and
returning, by the client, the confirmation response message to the server.

3. The method of claim 2, wherein the calculating, by the client, a similarity between the first graph and the verification graph includes:
obtaining, by the client, the first graph input on the graphic input interface; and
calling, by the client, a predetermined similarity algorithm to calculate the similarity between the first graph and the verification graph upon detecting completion of drawing the first graph.

4. The method of claim 2, wherein the calculating, by the client, a similarity between the first graph and the verification graph includes:
obtaining, by the client, in real time the first graph input on the graphic input interface; and
calling, by the client, the predetermined similarity algorithm to calculate the similarity between the first graph obtained in real time and the verification graph.

5. The method of claim 1, wherein the verification graph includes one or more of a geometric graph, a numerical graph, and a character graph.

6. A method for confirmation processing, the method comprising:
sending, by a server, a confirmation request message to a client corresponding to a target account upon detecting an event to be confirmed that is sent according to an operation of the target account;
calling, by the client, a graphic input interface upon receiving the confirmation request message;
displaying, by the client, the graphic input interface;
generating, by the client, a verification graph;
displaying, by the client, the verification graph;
obtaining, by the client, a first graph input on the graphic input interface;
in response to the first graph matching with the verification graph, returning, by the client, a confirmation response message to the server;
confirming, by the server, the event upon receiving the confirmation response message; and
responding, by the server, to one or more operations of the target account.

7-11. (canceled)

12. A confirmation-processing device comprising:
a calling module configured to call and display a graphic input interface upon receipt of a confirmation request message containing a verification graph from a server;
a display module configured to display the verification graph contained in the confirmation request message; and
a response module configured to obtain a first graph input on the graphic input interface, and in response to the first graph matching with the verification graph, return a confirmation response message to the server so that the server confirms a corresponding event according to the confirmation response message.

13. The device of claim 12, further comprising:
one or more data processors; and
a computer-readable storage medium;
wherein the calling module, the display module, and the response module are stored in the storage medium and configured to be executed by the one or more data processors.

14-19. (canceled)

20. A non-transitory computer readable storage medium comprising programming instructions for confirmation processing, the programming instructions configured to cause one or more data processors to execute operations comprising:
calling a graphic input interface upon receiving a confirmation request message that contains a verification graph from a server;
displaying the graphic input interface;
displaying the verification graph contained in the confirmation request message;
obtaining a first graph input on the graphic input interface; and
in response to the first graph matching with the verification graph, returning a confirmation response message to the server so that the server confirms a corresponding event according to the confirmation response message.

21-25. (canceled)
